(19) United States
(12) Patent Application Publication
(10) Pub. No.: US 2012/0140194 A1
(43) Pub. Date: Jun. 7, 2012

(54) Maskless Exposure Apparatus

(75) Inventors: Sang Woo Bae, Seoul (KR); Sang Don Jang, Suwon-si (KR)

(73) Assignee: SAMSUNG ELECTRONICS CO., LTD., Suwon-si (KR)

(21) Appl. No.: 13/293,445

(22) Filed: Nov. 10, 2011

(30) Foreign Application Priority Data
Dec. 1, 2010 (KR) 10-2010-0121568

(51) Int. Cl. G03B 27/52

(52) U.S. Cl. 355/55

(57) ABSTRACT

According to example embodiments, a maskless exposure apparatus includes a light source array including a plurality of light sources, a focusing element array including a plurality of focusing elements, and an image forming lens unit between the focusing element array and a substrate. The focusing element array is configured to perform a first focusing operation to focus light beams emitted from the plurality of light sources. The image forming lens unit is configured to perform a second focusing operation on the focused light beams to form focused light spots on the surface of the substrate. The focused light spots form a pattern on the substrate.

### CROSS-REFERENCE TO RELATED APPLICATION

This application claims priority under 35 U.S.C. §119 to Korean Patent Application No. 2010-0121568, filed on Dec. 1, 2010 in the Korean Intellectual Property Office (KIPO), the entire contents of which are incorporated herein by reference.

### BACKGROUND

1. Field

Example embodiments relate to a maskless exposure apparatus.

2. Description of the Related Art

A maskless exposure apparatus is used to directly form a pattern on a substrate, such as a film, a wafer or a glass substrate, using light without a mask. Such a maskless exposure apparatus forms the pattern on the substrate without a photo mask, and thus is advantageous in that it does not require manufacture of the mask having a high resolution and a large area and replacement of the mask due to foreign substances and damage.

Maskless exposure methods are generally classified into a maskless exposure method using a spatial light modulator (SLM) and a maskless exposure method in which light sources are directly modulated.

FIG. 1 is a cross-sectional view of a conventional maskless exposure apparatus using a light source array. As shown in FIG. 1, a conventional maskless exposure apparatus 100 includes a light source array 110, a focusing element array 120 and a control device 130.

The light source array 110 is formed in a one-dimensional or two-dimensional array structure in which a plurality of light sources 112 is arranged on a support substrate 114, and the focusing element array 120 is formed in a two-dimensional array structure in which focusing elements 122, the number of which corresponds to the number of the light sources 112, are arranged on a silicon substrate 124.

The control device 130 transmits a control signal to the respective light sources 112 so as to turn the respective light sources 112 on or off.

In the above maskless exposure apparatus 100, light beams emitted from the light sources 112 having received the control signal from the control device 130 are focused by the focusing elements 122 to form focused light spots 146 on a substrate 150, thereby transferring a desired pattern to the substrate 150.

In order to form the focused light spots 146 having a diameter of about 3.0 μm on the substrate 150 using the conventional maskless exposure apparatus 100, a distance d between the focusing elements 122 and the substrate 150, referred to as, a working distance, needs to be about 250 μm or less although the distance d is varied according to light divergence angles of the light sources 112. However, manufacture of the maskless exposure apparatus 100 having a minute working distance d of 250 μm or less is realistically difficult.

FIGS. 2(a) and 2(b) are views illustrating design structures of optical systems constituting the conventional maskless exposure apparatus.

FIG. 2(a) is a view illustrating a design structure of an optical system to form the focused light spots 146 having a diameter of 3.0 μm, if the light sources 112 have a diameter of 15 μm and the focusing elements 122 have a diameter of 35 μm. Here, a micro lens array (MLA) may be used as the focusing element array 120. In order to form the focused light spots 146 having the diameter of 3.0 μm, as shown in FIG. 2(a), the focusing elements 122 need to be arranged at a position separated from the light sources 112 by a distance of 2,500 μm so as to allow the distance d between the focusing elements 122 and the substrate 150 to be about 500 μm. Here, if light emitting diodes (LED) are used as the light sources 122, a light divergence angle of the light sources 122 is about 80°, and thus light usage efficiency, i.e., (0.8/80)̂2×100=0.01%, is very low.

FIG. 2(b) is a view illustrating a design structure of an optical system in which components and conditions are the same as those of FIG. 2(a) except that the focusing elements 122 have an increased diameter of 100 μm. Even in this case, light usage efficiency, i.e., (2.3/80)̂2×100=0.08%, is still low.

### SUMMARY

According to example embodiments, a maskless exposure apparatus includes a light source array including a plurality of light sources, a focusing element array including a plurality of focusing elements, and an image forming lens unit between the focusing element array and a substrate. The focusing element array is configured to perform a first focusing operation to focus light beams emitted from the plurality of light sources. The image forming lens unit is configured to perform a second focusing operation on the focused light beams to bun focused light spots on the surface of the substrate. The focused light spots form a pattern on the substrate.

According to example embodiments, the plurality of light sources includes laser diodes (LDs).

According to example embodiments, the plurality of light sources includes light emitting diodes (LEDs).

According to example embodiments, the plurality of light sources includes vertical cavity surface emitting lasers (VCSELs).

According to example embodiments, the plurality of focusing elements includes Fresnel lenses.

According to example embodiments, the plurality of focusing elements includes zone plate lenses.

According to example embodiments, the plurality of focusing elements includes micro lenses.

According to example embodiments, the plurality of focusing elements are configured to focus the light beams emitted from the plurality of light sources on random points before reaching the surface of the substrate.

According to example embodiments, the image forming lens unit includes at least one lens.

According to example embodiments, the maskless exposure apparatus further includes a collimating lens between the light source array and the focusing element array, the collimating lens configured to convert the light beams emitted from the plurality of light sources into parallel light beams.

According to example embodiments, the maskless exposure apparatus further includes a control device configured to calculate data regarding the pattern that is exposed on the substrate and configured to turn the plurality of light sources on or off based on the calculated pattern data.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cross-sectional view of a conventional maskless exposure apparatus using a light source array;

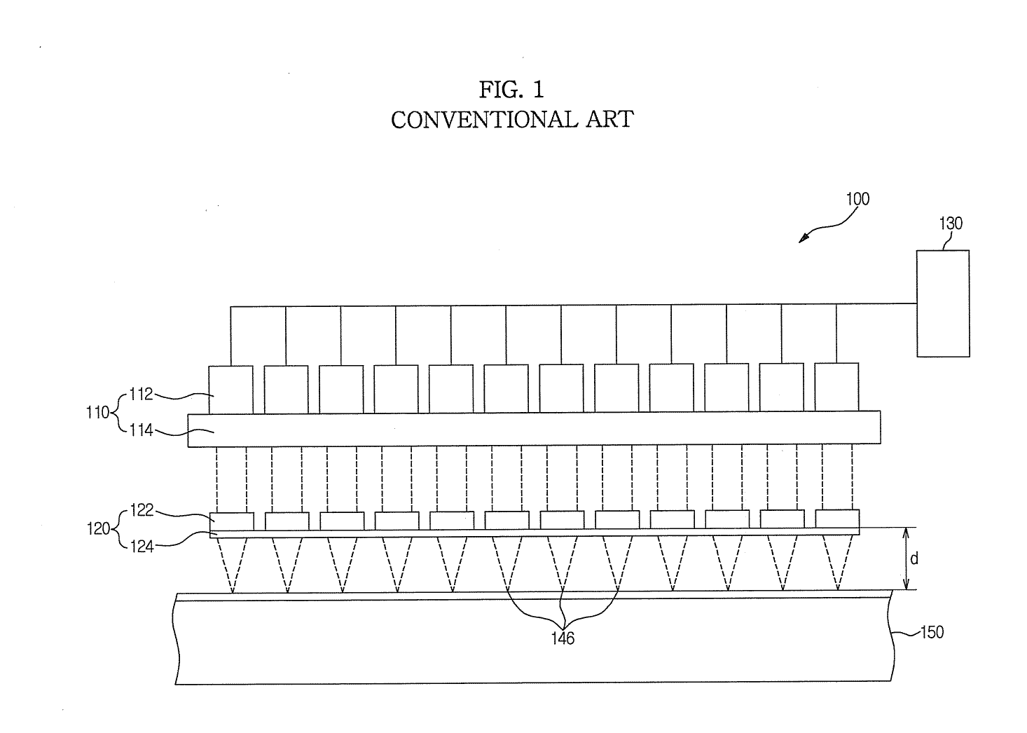

FIGS. 2(a) and 2(b) are views illustrating design structures of optical systems constituting the conventional maskless exposure apparatus;

FIG. 3 is a cross-sectional view of a maskless exposure apparatus in accordance with example embodiments;

FIG. 4 is a view illustrating an arrangement structure of a light source array and a focusing element array of the maskless exposure apparatus in accordance with example embodiments;

FIG. 5 is a view illustrating a structure of an optical system constituting the maskless exposure apparatus in accordance with example embodiments;

FIG. 6 is a view illustrating a structure of an optical system constituting a maskless exposure apparatus in accordance with example embodiments; and

FIG. 7 is a view illustrating a design structure of the optical system constituting the maskless exposure apparatus in accordance with example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

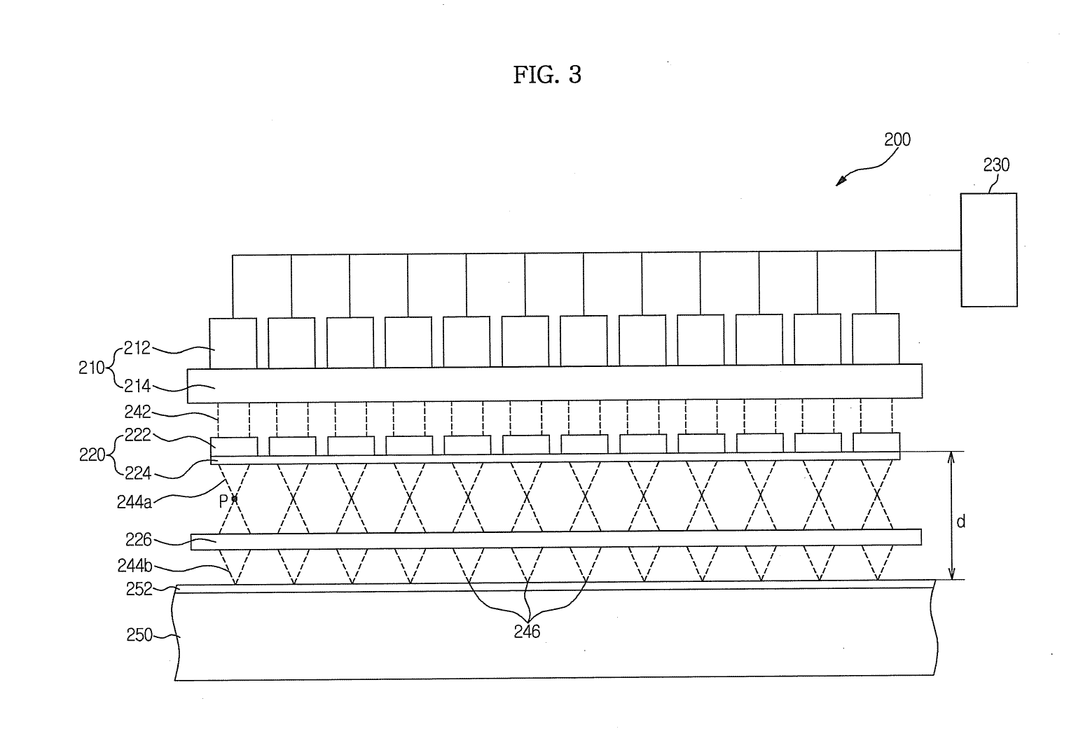

FIG. 3 is a cross-sectional view of a maskless exposure apparatus in accordance with example embodiments.

As shown in FIG. 3, a maskless exposure apparatus 200 includes a light source array 210, a focusing element array 220, an image forming lens unit 226 and/or a control device 230.

The light source array 210 is formed in a two-dimensional array structure in which a plurality of light sources 212 are arranged on a support substrate 214. The light sources 212 output light beams 242 to a substrate 250.

The focusing element array 220 is formed as a two-dimensional array structure in which focusing elements 222, the number of which corresponds to the number of the light sources 212, are arranged on a silicon substrate 224. The focusing elements 222 focus (or, alternatively converge) the light beams 242 emitted from the light sources 212 on random points P, thus generating first focused beams 244a.

The image forming lens unit 226 refocuses beams diffused from the first focused beams 244a, focused on the random points P by the focusing elements 222, thus generating second focused beams 244b. Focused light spots 246 are formed on the surface of the substrate 250, to which a photoresist 252 is applied, through generation of the second focused beams 244b by the image forming lens unit 226. Thereby, a desired pattern (image) may be foamed on the substrate 250. Here, the image forming lens unit 226 may include one lens, a plurality of lenses, each lens corresponding to a first focused beam 244a.

The control device 230 calculates data (exposure pattern data) regarding an exposure pattern to be exposed, and transmits a control signal to the respective light sources 212 based on the calculated exposure pattern data, thereby turning the respective light sources 212 on or off. For example, the exposure pattern is formed on the photoresist 252 on the surface of the substrate 250 without a mask by varying on/off of the light beams 242 emitted from the light source array 210.

As shown in FIG. 3, the maskless exposure apparatus 200 includes the image forming lens unit 226 between the focusing element array 220 and the substrate 250 and narrows an interval between the light source array 210 and the focusing element array 220, thereby enabling the light beams 242 emitted from the light sources 212 to be first focused on the random points before reaching the surface of the substrate 250 and then to be refocused on the substrate 250 by the image forming lens unit 226, and thus forming the focused light spots 246. Through such a structure, a distance d between the focusing elements 222 and the substrate 250, referred to as a working distance, may be increased.

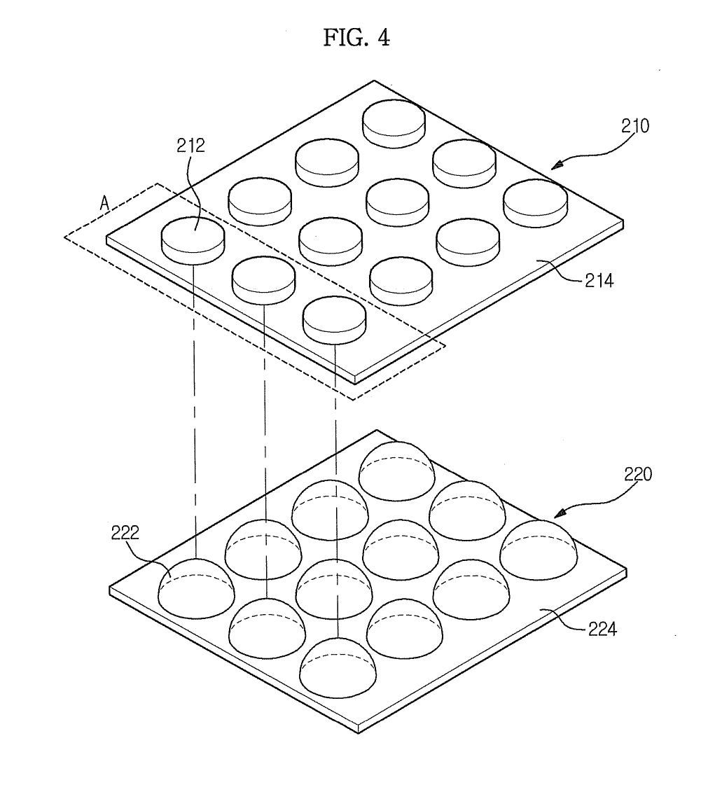

FIG. 4 is a view illustrating an arrangement structure of the light source array and the focusing element array of the maskless exposure apparatus in accordance with example embodiments.

As shown in FIG. 4, the plural light sources 212 are arranged in a two-dimensional array structure on the support substrate 214, thus forming the light source array 210.

Semiconductor lasers, laser diodes (LDs), light emitting diodes (LEDs), vertical cavity surface emitting lasers (VCSELs), or the like, may be used as the light sources 212. Elements forming the light sources 212 are arranged at a micrometer size scale and provide a very high modulation frequency (about 1 GHz), thus enabling modulation at a very high patterning speed.

Further, the plural focusing elements 222, the number of which corresponds to the number of the light sources 212, are arranged in a two-dimensional array structure on the silicon substrate 224, thus forming the focusing element array 220. Each of the light sources 212 and each of the focusing elements 222 are arranged in a straight line. Further, the respective focusing elements 222 define unit cells on the substrate 250 and perform an exposure process (formation of the focused light spots) only within the corresponding unit cells. Diffractive elements or refractive elements may be used as the focusing elements 222. For example, Fresnel lenses, zone plate lenses, micro lenses, or the like, may be used as the focusing elements 222.

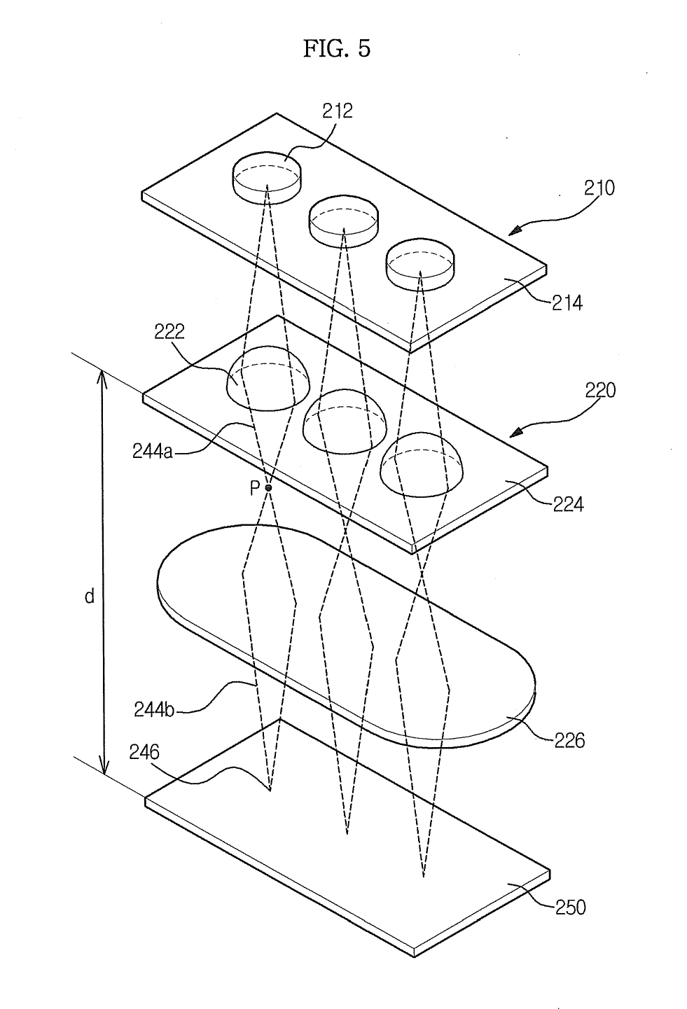

FIG. 5 is a view illustrating a structure of an optical system constituting the maskless exposure apparatus in accordance with example embodiments.

FIG. 5 illustrates a configuration of the optical system corresponding to three light sources 212 within a region A shown in a dotted line of FIG. 4, for convenience of illustration.

As shown in FIG. 5, the maskless exposure apparatus 200 includes the image forming lens unit 226 to be arranged between the focusing element array 220 and the substrate 250. Here, the image forming lens unit 226 may include one lens.

Now, with reference to FIG. 5, a process of forming the focused light spots 246 on the surface of the substrate 250 will be described. First, the light sources 212 having received a turning-on control signal from the control device 230 output the light beams 242 to expose the surface of the substrate 250. Here, a collimating lens (not shown) may be arranged between the light source array 210 and the focusing element array 220. In this case, the light beams 242 emitted from the light sources 212 pass through the collimating lens and are thus converted into parallel light beams, and the converted parallel light beams are incident upon the focusing elements 222.

The light beams 242 emitted from the light sources 212 pass through the focusing elements 222 and are thus focused (or, alternatively converged) on random points P before reaching the surface of the substrate 250, thereby generating the first focused beams 244a.

Light beams diffused from the first focused beams 244a, focused on the random points P by the focusing elements 222, pass through the image forming lens unit 226 and are thus focused on the surface of the substrate 250, thereby generating the second focused light beams 244b. The focused light spots 246 are formed on the surface of the substrate 250 through generation of the second focused beams 244b. Through such a structure of the optical system, the distance d between the focusing elements 222 and the substrate 250, referred to as the working distance, may be increased.

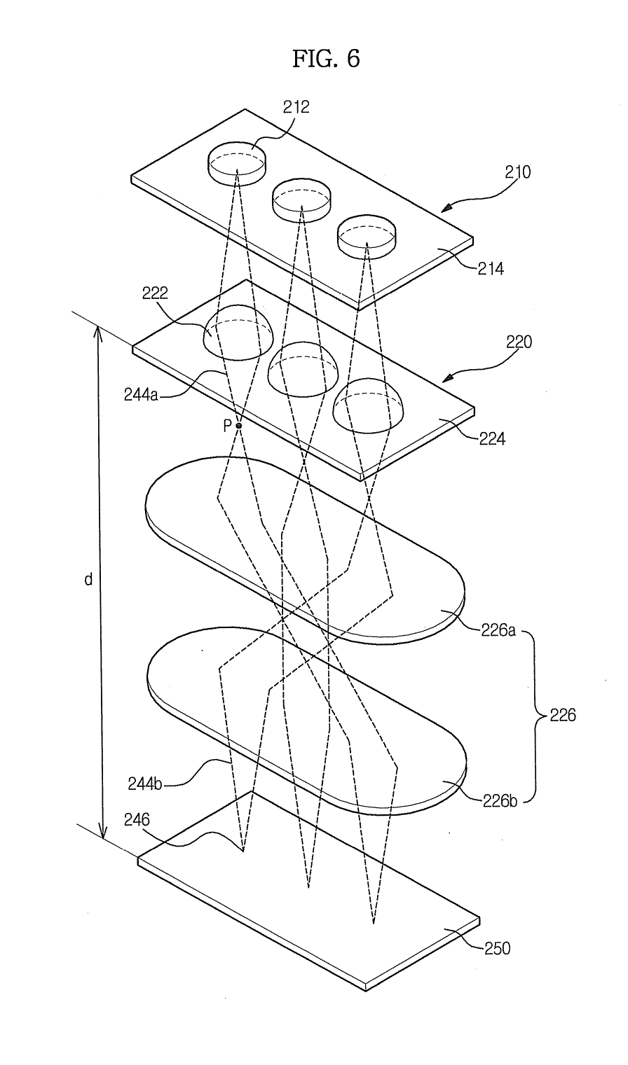

FIG. 6 is a view illustrating a structure of an optical system constituting a maskless exposure apparatus in accordance with example embodiments.

FIG. 6 illustrates a configuration of the optical system corresponding to three light sources 212 within a region A shown in a dotted line of FIG. 4, for convenience of illustration.

As shown in FIG. 6, the maskless exposure apparatus 200 includes the image forming lens unit 226 including a first lens 226a and a second lens 226b between the focusing element array 220 and the substrate 250.

Now, with reference to FIG. 6, a process of forming the focused light spots 246 on the surface of the substrate 250 will be described. First, the light sources 212 having received a turning-on control signal from the control device 230 output the light beams 242 to expose the surface of the substrate 250. Here, a collimating lens (not shown) may be arranged between the light source array 210 and the focusing element array 220. In this case, the light beams 242 emitted from the light sources 212 pass through the collimating lens and are thus converted into parallel light beams, and the converted parallel light beams are incident upon the focusing elements 222.

The light beams 242 emitted from the light sources 212 pass through the focusing elements 222 and are thus focused (or, alternatively converged) on random points P before reaching the surface of the substrate 250, thereby generating the first focused beams 244a.

Light beams diffused from the first focused beams 244a, focused on the random points P by the focusing elements 222, pass through the image forming lens unit 226 and are thus focused on the surface of the substrate 250, thereby generating the second focused light beams 244b. The focused light spots 246 are formed on the surface of the substrate 250 through generation of the second focused beams 244b. Through such a structure of the optical system, the distance d between the focusing elements 222 and the substrate 250, referred to as the working distance, may be increased.

Although FIG. 6 illustrates the image forming lens unit 226 including the two lenses 226a and 226b as being between the focusing element array 220 and the substrate 250, the image forming lens unit 226 may include three or more lenses between the focusing element array 220 and the substrate 250. In this case, the distance d between the focusing elements 222 and the substrate 250, referred to as the working distance, may be further increased.

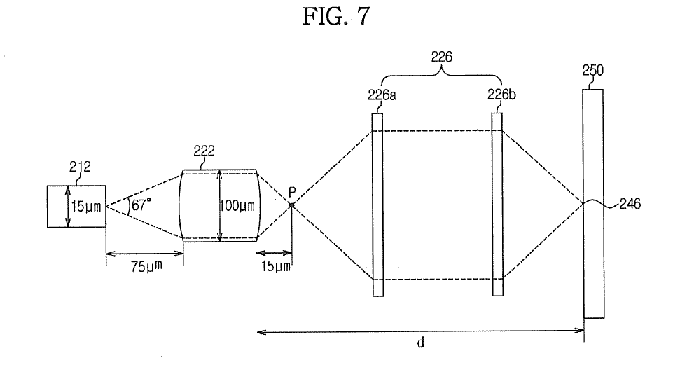

FIG. 7 is a view illustrating a design structure of the optical system constituting the maskless exposure apparatus in accordance with example embodiments.

FIG. 7 exemplarily illustrates the design structure of the optical system to faun the focused light spots 246 having a diameter of 3.0 μm, if the light sources 212 have a diameter of 15 μm and the focusing elements 222 have a diameter of 100 μm. Here, a micro lens array (MLA) may be used as the focusing element array 220. When the image forming lens unit 226 including the first lens 226a and the second lens 226b is arranged between the focusing element array 220 and the substrate 250, the light beams 242 emitted from the light sources 212 pass through the focusing elements 222 and are thus focused (or, alternatively converged) on the random points P before reaching the surface of the substrate 250, and are then diffused, and the diffused light beams pass through the image forming lens unit 226 and are thus focused on the surface of the substrate 250, thus forming the focused light spots 246. Here, by arranging the image fowling lens unit 226 between the focusing elements 222 and the substrate 250, the distance d between the focusing elements 222 and the substrate 250, referred to as the working distance, may be increased.

The working distance d may be relatively increased through such a structure of the optical system, and thus the interval between the light source array 210 and the focusing element array 220 may be further narrowed.

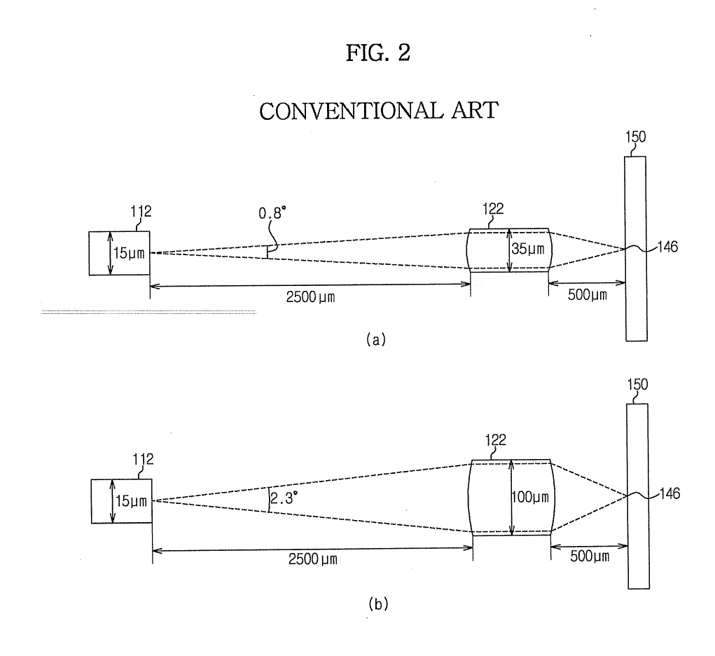

With reference to FIG. 2(b), in order to form the focused light spots 146 having a diameter of 3.0 μm using the light sources 112 having a diameter of 15 μm and the focusing elements 122 having a diameter of 100 μm in the conventional maskless exposure apparatus, the focusing elements 122 need to be arranged at a position separated from the light sources 112 by a distance of about 2,500 μm. However, in the optical system shown in FIG. 7, in order to faint the focused light spots 246 having the same diameter (3.0 μm) using the light sources 212 having the same diameter (15 μm) and the focusing elements 122 having the same diameter (100 μm), the focusing elements 222 may be arranged at a position separated from the light sources 212 by a distance of about 75 μm. Since the interval between the light sources 212 and the focusing elements 222 may be further narrowed, an incidence angle of the light beams 242 which are emitted from the light sources 212 and are then incident upon the focusing elements 222 is increased.

Comparing the optical system shown in FIG. 7 and the optical system shown in FIG. 2(b), the interval between the light sources 212 and the focusing elements 222 is decreased to 75 μm from the interval (2,500 μm) between the light sources 112 and the focusing elements 122, and the angle of incidence of the light beams 246 which are emitted from the light sources 212 and are then incident upon the focusing elements 222 is increased to 67° from the angle of incidence) (2.3° of the light beams 146 which are emitted from the light sources 112 and are then incident upon the focusing elements 122.

If light emitting diodes (LEDs) are used as the light sources 222 in the optical system shown in FIG. 7, the divergence angle of the light beams 246 emitted from the light sources 222 is about 80°, and thus it is understood that light usage efficiency, i.e., (67/80)̂2×100=71%, is improved.

As is apparent from the above description, a maskless exposure apparatus in accordance with example embodiments increases a distance between an optical system (focusing elements) and a substrate, referred to as a working distance, thus being easily manufactured with relative ease and improved light usage efficiency.

While example embodiments have been particularly shown and described, it will be understood by one of ordinary skill in the art that variations in form and detail may be made therein without departing from the spirit and scope of the claims.

What is claimed is:

1. A maskless exposure apparatus comprising:
a light source array including a plurality of light sources;
a focusing element array including a plurality of focusing elements configured to perform a first focusing operation to focus light beams emitted from the plurality of light sources; and
an image forming lens unit between the focusing element array and a substrate and configured to perform second focusing operation on the focused light beams to form focused light spots on the surface of the substrate, the focused light spots forming a pattern on the substrate.

2. The maskless exposure apparatus according to claim 1, wherein the plurality of light sources includes laser diodes (LDs).

3. The maskless exposure apparatus according to claim 1, wherein the plurality of light sources includes light emitting diodes (LEDs).

4. The maskless exposure apparatus according to claim 1, wherein the plurality of light sources includes vertical cavity surface emitting lasers (VCSELs).

5. The maskless exposure apparatus according to claim 1, wherein the plurality of focusing elements includes Fresnel lenses.

6. The maskless exposure apparatus according to claim 1, wherein the plurality of focusing elements includes zone plate lenses.

7. The maskless exposure apparatus according to claim 1, wherein the plurality of focusing elements includes micro lenses.

8. The maskless exposure apparatus according to claim 1, wherein the plurality of focusing elements are configured to focus the light beams emitted from the plurality of light sources on random points before reaching the surface of the substrate.

9. The maskless exposure apparatus according to claim 1, wherein the image forming lens unit includes at least one lens.

10. The maskless exposure apparatus according to claim 1, further comprising:
a collimating lens between the light source array and the focusing element array, the collimating lens configured to convert the light beams emitted from the plurality of light sources into parallel light beams.

11. The maskless exposure apparatus according to claim 1, further comprising:
a control device configured to calculate data regarding the pattern that is exposed on the substrate and configured to turn the plurality of light sources on or off based on the calculated pattern data.
